(19) United States
(12) Patent Application Publication
(10) Pub. No.: US 2017/0368552 A1
(43) Pub. Date: Dec. 28, 2017

(54) Spherical Joint for Hammer Mills

(71) Applicant: Jacobs Corporation, Harlan, IA (US)

(72) Inventor: Chad J. Plumb, Harlan, IA (US)

(21) Appl. No.: 15/193,680

(22) Filed: Jun. 27, 2016

(51) Int. Cl. B02C 13/28; F16C 11/06

(52) U.S. Cl. CPC B02C 13/28; F16C 11/0685; F16C 11/0614; F16C 2320/23

(57) ABSTRACT

A method of providing for a manually insertable bushing in a spherical joint. By forming slots, strategically located and sized, the bushing may be inserted manually into the race, then rotated into position in the race. The bushing may be disallowed from exiting via the slots by engaging the bushing to a shaft, or by a keeper affixed to cover the slots.

### BACKGROUND OF THE INVENTION

### Field of the Invention

The present invention relates to hammer mills. More particularly, this invention relates to an improved spherical joint to which hammers in hammer mills are operatively attached.

Hammer mills are a common tool for crushing, grinding, or comminution of a wide variety of materials. For example, hammer mills are used to process forestry products, agricultural products, minerals, and materials for recycling. Specific examples of materials processed by hammer mills include grains, animal food, pet food, feed ingredients, mulch, wood, hay, plastics, concrete, aggregate materials, and dried distiller grains.

A typical hammer mill comprises a rotor mounted on a rotor shaft inside a housing. Hammer mills have an advantage over other grinding mechanisms in that, if the material to be reduced fails to yield to a hammer's blow, that hammer is simply deflected and other hammers will strike the same material until it does yield.

A typical hammer mill comprises a rotor assembly mounted on a rotor shaft inside a housing. A rotor assembly 1100 is illustrated at rest in FIGS. 11 and 13 of Plumb et al. U.S. Pat. No. 8,104,177, and U.S. Pat. No. 8,342,435, both of which patents are incorporated herein by reference. A material inlet is generally located at the top of the housing with one or more material outlets located near the bottom of the housing. As shown in FIGS. 11 to 13 of the Plumb et al. '177 Patent, the rotor assembly 1100 includes a drive shaft and rows of hammers 1400, as illustrated in FIG. 14 of the Plumb et al. '177 Patent. The hammers 1400 are pivotally connected to the rotor 1100 by a steel hammer rod or pin. The hammers are normally flat steel blades or bars, as illustrated in FIGS. 11 to 14. The hammers extend out substantially radially from the hammer rods due to inertia when the hammer mill rotates, that is, is in operation, as illustrated in FIG. 12. The rotor assembly 1100 is mounted inside a housing, known by those skilled in the hammer art as a grinding or working chamber.

An apparatus for attaching hammers within a hammer mill is disclosed in U.S. Pat. No. 7,419,109 by Ronfeldt et al., which is also hereby incorporated by reference.

Present-day cutting plates comprise an upper, linear section, and do not allow particles to escape. Downstream of the cutting plate, the interior of the working chamber is defined by curved screen plates. The screen opening diameter is selected to match the desired final particle size of the material being comminuted. Particles less than or equal to the desired size exit the chamber though the screens, while material greater than the desired size are further reduced by the rotating hammers 1400 (still referring to the prior art shown in U.S. Pat. Nos. 8,104,177 and 8,342,435).

Standard hammers, when grinding a product in a hammer mill, impact the product to be pulverized to create a smaller average particle size. This impact forces material against a perforated screen area that also cuts and sizes the product. Inside the typical hammer mill, numerous forces act. A spherical joint, comprising a bushing and a race, is used to attach the hammer to the shaft. Such a joint does not support loads to the hammer parallel to the shaft until the spherical joint has reached its limit of travel. Therefore, bushing wear due to said loading is greatly diminished.

For the purposes of the present document, including the claims, a spherical joint is defined as follows. It comprises a bushing 220 and a race 310 (see FIGS. 2 and 3 of the present document). The surfaces of the bushing and the race in contact with one other are generally described, mathematically, as portions of a cylindrical surface 110, depicted in FIG. 1A. The surface of a cylinder 110 may be described in rectangular coordinates as:

x²+y²+z²=R²

where x, y, and z are the usual Cartesian coordinates shown in FIG. 1A and R is the radius (half the diameter) of the spherical surface. The bushing 220 and a race 310 surfaces are confined, geometrically, between two parallel planes 120, 130 as shown in FIG. 1A. These planes 120, 130 are depicted as planes of constant x, equidistant from the origin or center 170 of the sphere in FIG. 1A, but any two parallel planes 120, 130, equidistant from the center of the sphere 170 and spaced appropriately provide the same shape for the bushing 220 and race 310 surfaces. The bushing 220 surface and the race 310 surface, then, are shown in FIG. 1A as the portion of the cylinder's surface residing between the two parallel planes 120, 130. The race 310 surface has a slightly larger diameter or radius than that of the bushing 220 so the bushing 220 may readily move within the race 310 under the influence of a force or torque. The race 310 surface would typically be defined by a closer spacing between the two parallel planes 120, 130 compared to the bushing 210 surface.

For the purposes of the present document, including the claims, a cylindrical coordinate system is defined as shown in FIGS. 1A and 1B. An axial direction, x 140, is perpendicular to the two parallel planes 120, 130 and passes through the center 170 of the sphere 110. For instance, when the member is a hammer mill hammer, the x-direction (x-axis) 140 is perpendicular to the broader faces of the hammer mill hammer 100, as seen in FIG. 1B. An angular or tangential direction, θ 150, is orthogonal to the axial direction, x 140, the rotational direction being in accordance with a right-hand coordinate system. The radial direction, r 160, is orthogonal to both the z-direction 140 and the θ-direction 150. The r-direction (r-axis) 160 points in any θ-direction 150 beginning at the x-axis.

The advantages of a spherical joint in hammer mills notwithstanding, the bushing in the race in present-day spherical joints must be pressed or forged together, making manufacture costly and replacement of just the bushing difficult. Heat treating must be done after assembly of the bushing into the race. Hence, there are serious limitations for the materials used for bushing and race.

Therefore, there is a need for a spherical joint wherein the bushing may be inserted into the race without undue force or material deformation. There is a further need for a method and apparatus whereby the bushing and race may be heat treated separately.

### BRIEF SUMMARY OF THE INVENTION

An object of the instant invention is to provide a method and apparatus for manufacturing and assembling a spherical joint, such as used in hammer mills, such that the bushing may be inserted into the race using only manual force.

To effect the above objective, slots or broadened regions, centered about a diameter in the circumference of the race—said regions generally slightly wider than the bushing thickness—are formed from a first face of the hammer to the center of the race's thickness and to the maximum diameter of the race. The second face of the hammer is not modified, so the race appears as a circle at that second face. For assembly, the bushing is inserted in the x-direction into the aforementioned broadened regions in the first face of the hammer to the center of the race where the cylindrical shape of the inner surface of the race disallows further insertion. The bushing is then rotated on an axis parallel to the radial direction, r, to engage it in the race. Once installed on the shaft in the hammer mill, the bushing cannot rotate to a position whereby it may exit the race.

Because the spherical joint of the present invention may be heat treated before assembly, the heat treatments and materials of the separate bushing and race may be different.

The novel features believed to be characteristic of this invention, both as to its organization and method of operation together with further objectives and advantages thereto, will be better understood from the following description considered in connection with the accompanying drawings in which a presently preferred embodiment of the invention is illustrated by way of example. It is to be expressly understood however, that the drawings and examples are for the purpose of illustration and description only, and not intended in any way as a definition of the limits of the invention.

### BRIEF DESCRIPTION OF THE SEVERAL VIEWS OF THE DRAWINGS

FIG. 1A is a plot of a sphere and two parallel planes equidistant from the sphere's center;

FIG. 1B defines a cylindrical coordinate system useful for describing the present invention;

FIG. 2 is a perspective view of a hammer mill hammer blade with an integral race and bushing installed therein;

FIG. 3 is a perspective view of the hammer mill hammer blade with an integral race, the bushing is also illustrated but is separated from the race;

FIG. 4 is a perspective view of the hammer mill hammer blade with an integral race showing how the bushing is inserted into the race;

FIG. 4A is a front elevation view of the hammer mill hammer blade with an integral race and bushing installed therein, the bushing features an elongated hole for the shaft;

FIG. 5 is a front elevation view of the hammer mill hammer blade with an integral race and bushing installed therein;

FIG. 6A is a sectioned view of the hammer mill hammer blade with an integral race and bushing installed therein, the section being indicated in FIG. 5;

FIG. 6B is the sectioned view of FIG. 6A with the bushing removed;

FIG. 7A is a sectioned view of the hammer mill hammer blade with an integral race and bushing installed therein, the section being indicated in FIG. 5;

FIG. 7B is the sectioned view of FIG. 7A with the bushing removed;

FIG. 8A is a side elevation view of the hammer mill hammer blade with an integral race and bushing installed therein and the bushing mounted on a shaft showing a range of motion of the hammer mill hammer blade;

FIG. 8B is a side elevation view of the hammer mill hammer blade with an integral race and bushing installed therein and the bushing mounted on a shaft, the hammer mill hammer blade shown rotated on the bushing;

FIG. 9 is a sectioned view of an upper portion of the hammer mill hammer blade with an integral race and bushing installed therein;

FIG. 10 is a side elevation view of three hammer mill hammer blades with integral races and bushings installed in them, said bushings mounted on a single shaft;

FIG. 11 is a perspective view of a hammer mill hammer blade with a keeper to maintain the bushing in its installed position; and

FIG. 12 is a perspective view of the hammer mill hammer blade with the bushing and keeper separated from the race.

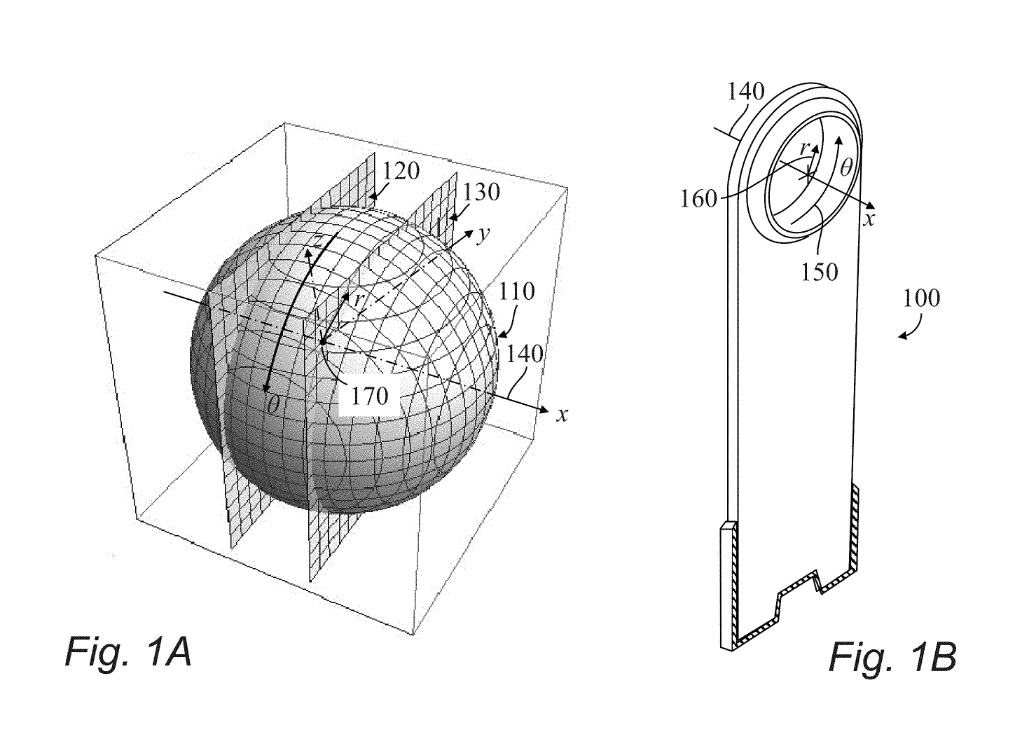

### DETAILED DESCRIPTION OF THE INVENTION

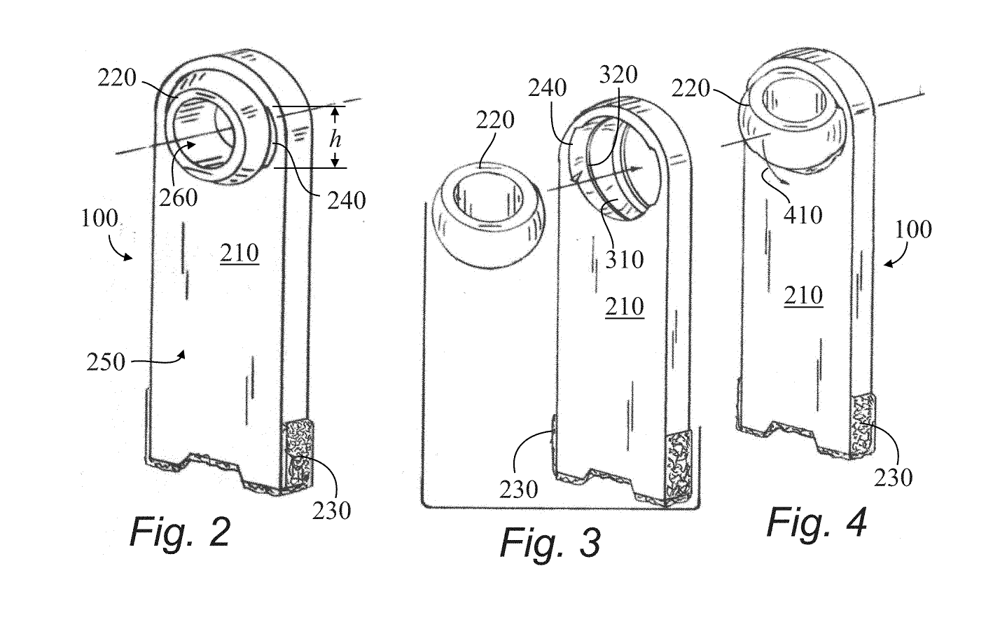

Referring now to the drawings, wherein like reference numerals designate identical or corresponding parts throughout the several views, FIGS. 2-4 show a hammer mill hammer blade assembly 100, comprising a hammer blade body 210, and a bushing 220 installed in an integrated bearing race 310.

The hammer blade body 210 preferably also comprises a hardened portion 230 where the hammer blade body 210 is likely to impact the material being crushed or ground.

As described above, the surfaces of the bushing 220 and race 310 generally in contact with one another are spherical in shape. The spherical region on the bushing 220 can be described as generally the outer periphery of the bushing 220. The spherical region of the race 310 may be described as generally the inner periphery of the race 310.

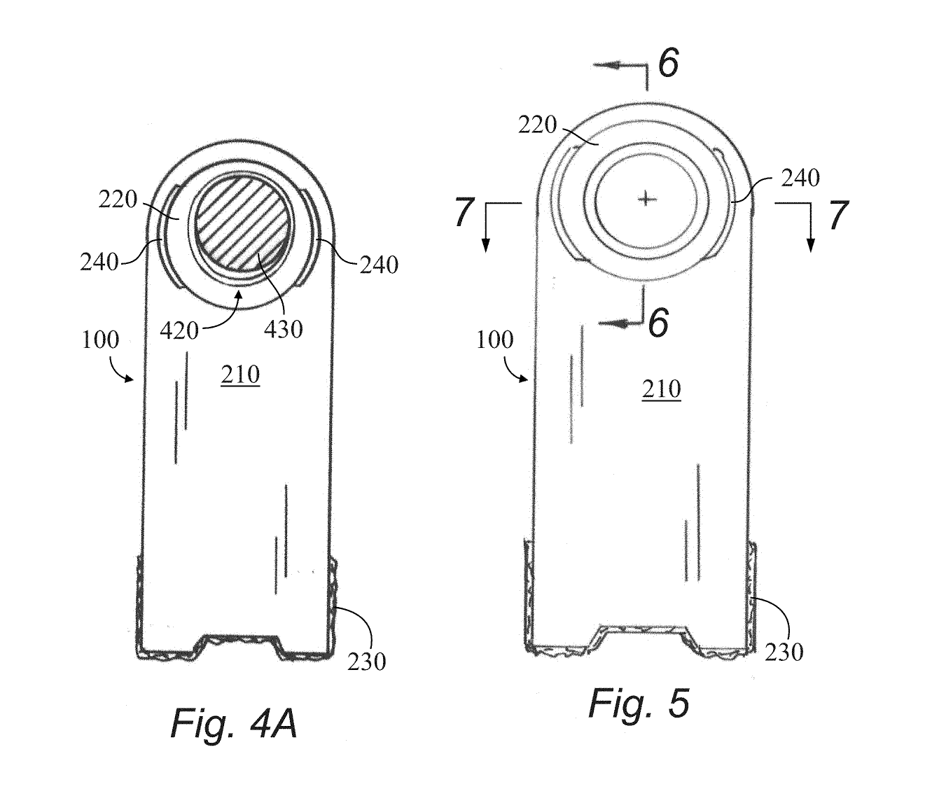

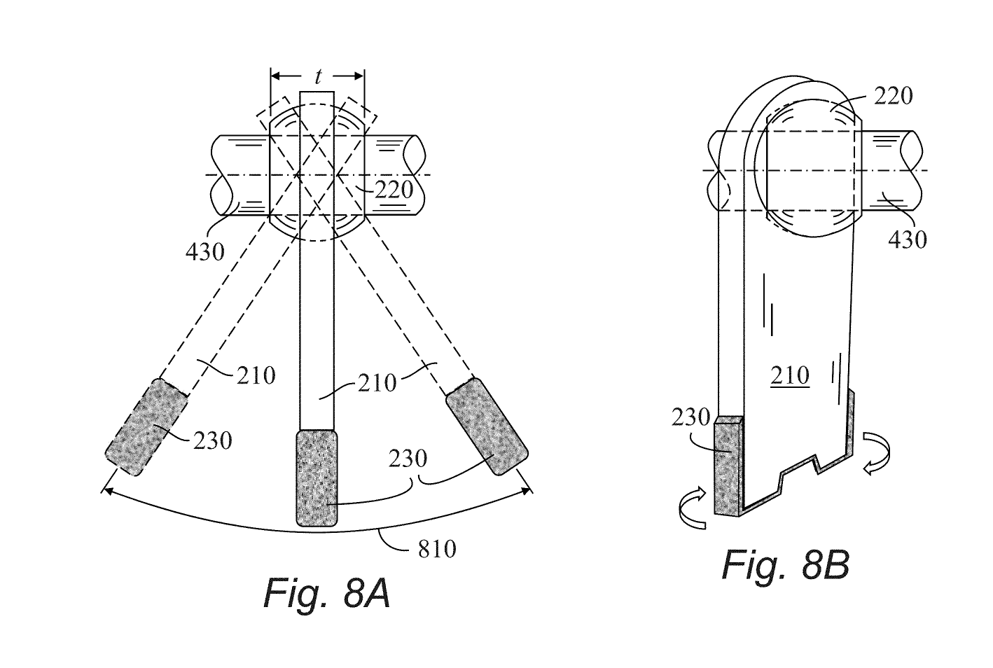

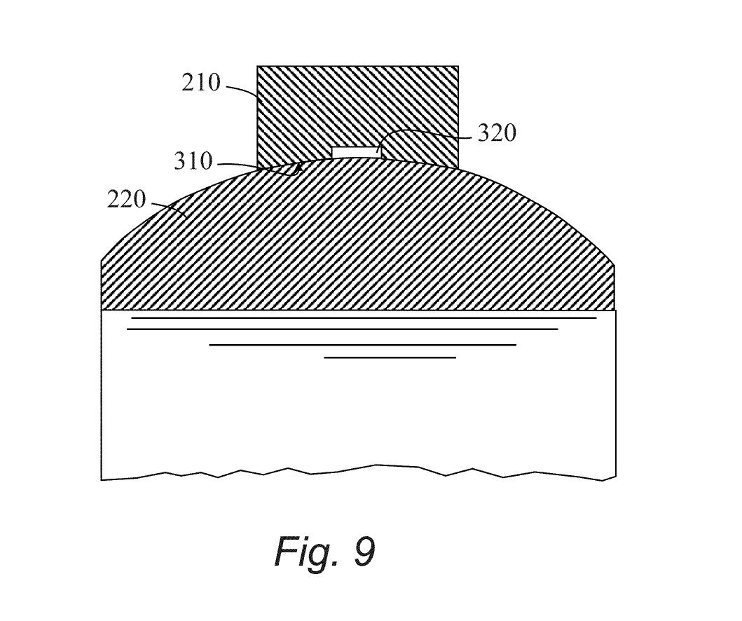

Installation of the bushing 220 into the race 310 is illustrated by the series, FIGS. 3 and 4. The race 310 is formed in the hammer blade body 210, and is modified by two diametrically opposite slots 240, sized and shaped to receive the bushing 220. The slots extend in the race's 310 x-direction 140 from one outer surface 250 to a plane at which the race's 310 diameter is greatest—at the center of the race 310 in the x-direction 140. The width h of the slots 240 is preferably slightly greater than the thickness, t (see FIG. 8A), of the bushing 220 to permit manual installation of the bushing 220 into the race 310. The bushing 220 is disposed in an appropriate position, as shown in FIG. 3, to enter the slots 240, with the bushing's 220 axial direction 140 generally perpendicular to the race's 310 axial direction 140. The bushing 220 is then inserted parallel to the race's 310 axial direction 140 into the slots 240 until the bushing's 220 greatest diameter reaches the race's 310 greatest diameter, at which point the bushing 220 cannot progress farther due to the narrowing of the race 310 in that direction. The center points 170 of the spherical surfaces of the bushing 220 and the race 310 are then coincident. This point in the process is shown in FIG. 4.

The bushing 220 is then rotated in the direction 410 shown, the axis of rotation of this direction is parallel to the radial direction, 160. The bushing 220 may be rotated on an axis of rotation parallel to the x-axis 140 before rotating said bushing 220 about the r-axis 160, but the final position is the same.

A modification to the spherical surface of the race 310 may be seen in FIG. 3. A groove 320 may be machined, stamped, or otherwise formed at the maximum radius point of the spherical surface of the race 310.

Further considering FIG. 3, since the bushing 220 and race 310 are separate and may be assembled at any time after those two parts 220, 310 are created, heat treatment or other surface treatment may be carried out on the bushing 220 exclusive of the race 310 and on the race 310 exclusive of the bushing 220. (Heat treatment includes quenching and tempering, annealing, and hardening. Surface treatments include shot peening, laser peening, galvanizing, and case hardening. This is not an exhaustive list, and those of ordinary skill in this art are well versed in the various treatments of the metals used in these spherical joints.) Especially due to this fact, the materials used for the bushing 220 are not limited by the heat or surface treatment of the race 310, nor are the materials used for the race 310 limited by the heat or surface treatment of the bushing 220. This adds significant flexibility in manufacture, may reduce material and manufacturing costs, and increase the life of the spherical joint.

Whereas an aperture 260 in the bushing 220 shown in FIGS. 2-4 is circular in cross section, the aperture 420 in the bushing 220 of FIG. 4A is shown noncircular, in an elongated, oval, elliptic, or egg shape. This alternative is disclosed in U.S. patent application Ser. No. 15/093,199, filed Apr. 7, 2016, now U.S. Pat. No. ______, which is hereby incorporated herein by reference in its entirety.

To clearly depict the noncircular aperture 420 in the bushing 220, a shaft 430, which is circular in cross section, or a right circular cylinder in shape, is shown disposed inside the aperture 420 of the bushing 220.

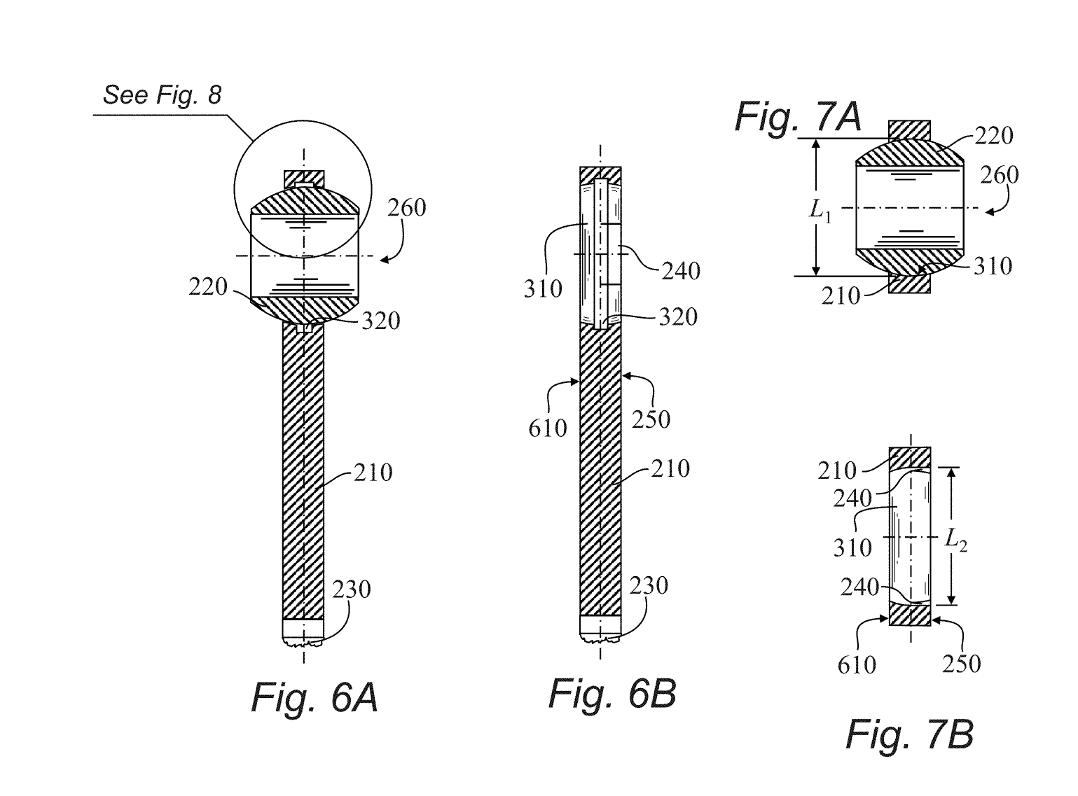

The bushing 220 and race 310 assembly of the present invention is shown in a front elevation view in FIG. 5. The section at which FIGS. 6A and 6B is viewed is shown in FIG. 5.

FIG. 6A illustrates a section through the coincident center points 170 of the spherical surfaces of the race 310 and bushing 220.

The bushing 220 has been removed from the sectional view of FIG. 6A in FIG. 6B. In this view, the spherical race surface 310 and the groove 320 are exposed. One slot 240 is shown extending from the face 250 on the right of the hammer blade body 210 to a plane midway between the right face 250 and the left face 610. Relative to the spherical surface of the race 310, the depth of the slots 240 is greatest at the right face 250 of the hammer blade body 210. The slots 240 preferably become flush with the spherical surface of the race 310 at the plane midway between the right face 250 and the left face 610.

The sectional view of FIG. 7A is indicated in FIG. 5. FIG. 7A is another section through the coincident center points 170 of the spherical surfaces of the race 310 and bushing 220, this time looking along the length of the hammer blade body 210. The spherical surface of the race 310 is shown without a groove 320 in FIG. 7A.

The maximum diameter of the bushing 220 is shown in FIG. 7A as L₁.

In the sectional view of FIG. 7B, the slots 240 may be seen extending from the face 250 on the right of the hammer blade body 210 to a plane midway between the right face 250 and the left face 610. The remainder of the surface of the race 310 is spherical.

The distance between the surfaces of the slots 240 is indicated in FIG. 7B as L₂. This distance is preferably slightly greater than the maximum diameter of the bushing 220, L₁, in FIG. 7A to admit the bushing 220 into the slots 240 without binding.

The hammer blade body 210 may rotate about the center point 170 of the spherical surface of the bushing 220 as shown in FIG. 8A. The center points 170 of the spherical surfaces of the bushing 220 and race 310 coincide as long as the bushing 220 is engaged properly in the race 310. The hammer blade body 210 may rotate until the edges of the race 310 contact the shaft 430, thereby providing a range of motion 810 and disallowing the bushing 220 to rotate to a position that it may exit the race 310 via the slots 240. To reach the position required for the bushing 220 to slide out the slots 240, the x-axis of the bushing 220 surface must be normal to the x-axis of the race 310 surface. It is impossible for the bushing 220, when engaged to the shaft 430, to be disposed in this orientation.

Shown in FIG. 8B is the hammer blade body 210 rotated about a radial direction 160 different from the radial direction 160 rotated about in FIG. 8A. It should be noted, the hammer blade body 210 may be rotated about any radial axis 160—that is, any radial axis at any angle, θ 150.

FIG. 9 shows the detail indicated in FIG. 6A. The hammer blade body 210 is shown with its integral race surface 310. The bushing 220 is installed and the groove 320 in the otherwise spherical race surface 310 is indicated.

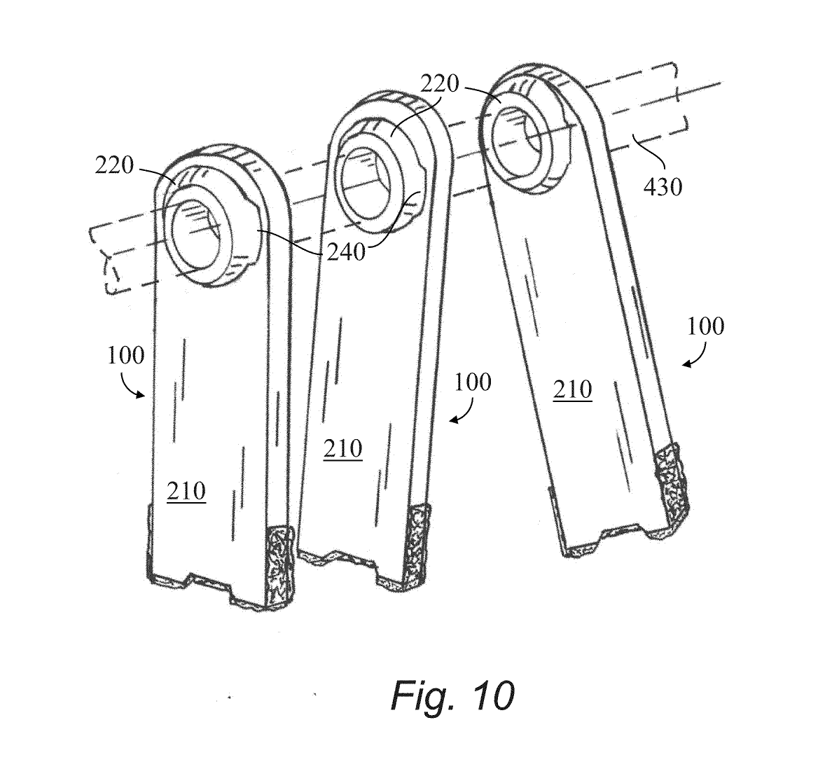

A single hammer mill hammer assembly 100 is not typically used alone. A set of three hammer mill hammer assemblies 100 installed on a shaft 430 are illustrated in FIG. 10. Material to be ground, shredded, or crushed is struck in different places simultaneously or at different times by the plurality of hammer mill hammer assemblies 100 installed on a shaft as well as hammer mill hammer assemblies 100 installed on other shafts within the hammer mill. Any of the bushings 220 installed in the integral races 310 in these hammer mill hammer assemblies 100 may be removed after the hammer mill hammer assembly 100 is disengaged from the shaft 430 by reversing the process illustrated in the series of figures, FIG. 3 through FIG. 4.

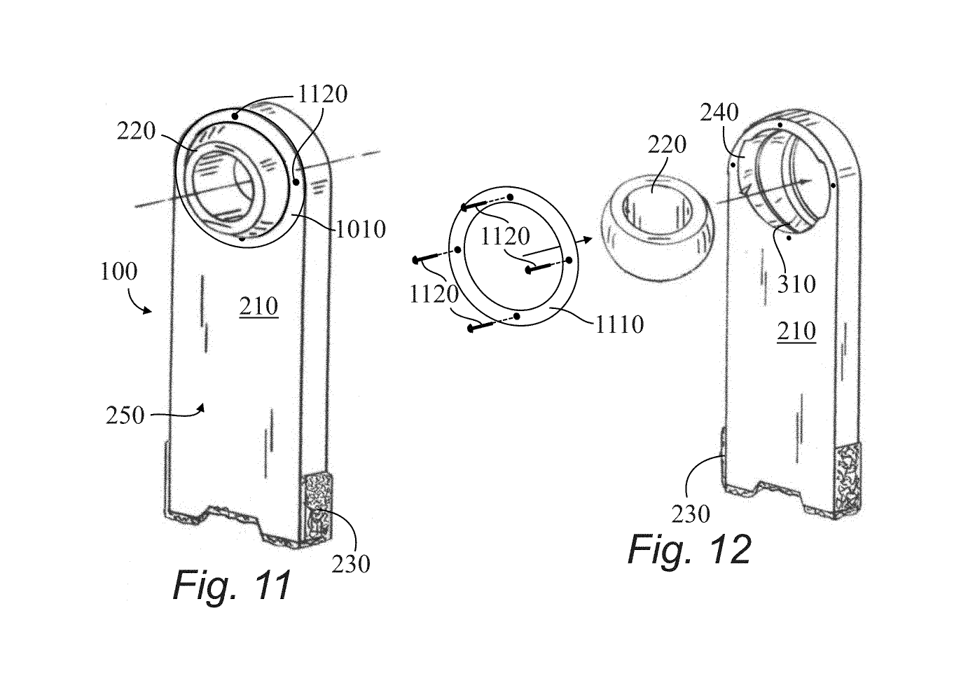

FIG. 11 illustrates another aspect to the present invention. The integral race 310 is formed in the hammer blade body 210, and is modified by the two diametrically opposite slots 240, sized and shaped to receive the bushing 220 just as above. However, the hammer 210 or other item in which the integral race is formed may be used in applications in which the shaft 430 is sometimes removed. In this case, the bushing 220 may be held in place in the race 310—even when the bushing is rotated to align with the slots 240—by a keeper 1110. The keeper 1110 may be attached to the hammer blade body 210, or other item in which the integral race is formed, by fasteners 1120, such as machine screws, rivets, or bolts.

Since little or no load is typically anticipated when the bushing 220 is not engaged on the shaft 430, the keeper 1110 typically need not be heavy. The race 310 is made adequately strong to withstand the stresses experienced by the hammer blade body 210 or other item when the shaft 430 is engaged in the bushing 220.

Assembly of the hammer mill hammer blade assembly 100 with the keeper 1110 is illustrated in FIG. 12. The bushing 220 is disposed in an appropriate position, as shown in FIG. 12, to enter the slots 240, with the bushing's 220 axial direction 140 generally perpendicular to the race's 310 axial direction 140. The bushing 220 is then inserted parallel to the race's 310 axial direction 140 into the slots 240 until the bushing's 220 greatest diameter reaches the race's 310 greatest diameter, at which point the bushing 220 cannot progress farther due to the narrowing of the race 310 in that direction. The center points 170 of the spherical surfaces of the bushing 220 and the race 310 are then coincident.

The bushing 220 is then rotated in the direction 410 shown in FIG. 4, the axis of rotation of this direction is parallel to the radial direction, 160. The bushing 220 may be rotated on an axis of rotation parallel to the x-axis 140 before rotating said bushing 220 about the r-axis 160, but the final position is the same. Finally, the keeper 1110 is applied and operatively fastened by fasteners 1120, such as machine screws, rivets, or bolts, to the hammer blade body 210 to maintain the bushing 220 in place even if it rotates to be aligned with the slots 240.

Although only an exemplary embodiment of the invention has been described in details above, those skilled in the art will readily appreciate that many modifications are possible without materially departing from the novel teachings and advantages of this invention. Accordingly, all such modifications are intended to be included within the scope of this invention as defined in the following claims.

What is claimed is:

1. A method of providing a manually installable bushing into a race for a spherical joint, the method comprising:
(a) creating a bushing comprising a spherical surface and a thickness;
(b) creating a race comprising a spherical surface between a first face and a second face;
(c) forming at least one slot extending from the first face of the race to midway between the first face and the second face; and
(d) sizing said at least one slot to have a width at least as great as the thickness of the bushing, and providing space to permit insertion of the bushing into the race.

2. The method of claim 1 additionally comprising:
(a) orienting the bushing to align with the at least one slot;
(b) inserting the bushing into the race until a first center point of the spherical surface of the bushing coincides with a second center point of the spherical surface of the race; and
(c) rotating the bushing about a radial axis.

3. The method of claim 1 wherein the spherical surface of the race comprises a first spherical surface, and the race also comprises a second spherical surface.

4. The method of claim 3 wherein the first spherical surface and the second spherical surface are separated by a groove;

5. The method of claim 1 wherein providing space to permit insertion of the bushing into the race comprises forming a surface of the at least one slot so that a distance to a surface on the race diametrically opposite the surface of the at least one slot is at least a maximum diameter of the bushing.

6. The method of claim 5 wherein the at least one slot comprises a first slot, the method additionally comprising forming a second slot diametrically opposite the first slot, said second slot comprising a surface.

7. The method of claim 2 additionally comprising:
(a) operatively affixing a keeper to the first face of the race;
(b) covering the at least one slot with the keeper;
(c) permitting a rotation of the bushing within the race; and
(d) disallowing the bushing to exit the race via the at least one slot by virtue of the keeper.

8. The method of claim 1 wherein creating a bushing comprises forming an aperture in the bushing, the aperture being circular in cross section.

9. The method of claim 1 wherein creating a bushing comprises forming an aperture in the bushing, the aperture being noncircular in cross section.

10. The method of claim 8 additionally comprising engaging a shaft with the bushing.

11. The method of claim 9 additionally comprising engaging a shaft with the bushing.

12. The method of claim 1 additionally comprising creating the race in a hammer mill hammer body.

13. The method of claim 1 additionally comprising treating the bushing using a treatment selected from the group heat treatment and surface treatment separately from the race.

14. The method of claim 1 additionally comprising treating the race using a treatment selected from the group heat treatment and surface treatment separately from the bushing.

15. The method of claim 1 wherein creating the bushing comprises using materials to make the bushing that are different than the materials used to make the race.

16. A method of manually removing a bushing from a race of a spherical joint, the method comprising:
(a) creating a bushing comprising a spherical surface and a thickness;
(b) creating a race comprising a spherical surface between a first face and a second face;
(c) forming at least one slot extending from the first face of the race to midway between the first face and the second face;
(d) sizing said at least one slot to have a width at least as great as the thickness of the bushing, and providing space to permit insertion of the bushing into the race;
(e) disposing the bushing in the race;
(f) orienting the bushing to align with the at least one slot;
(g) removing the bushing from the race.

17. An apparatus for providing for a spherical joint having a manually insertable bushing, the apparatus comprising:
(a) a bushing having a bushing width and a diameter;
(b) a spherical surface on a general outer periphery of the bushing;
(c) an aperture in a center of the bushing;
(d) a race;
(e) a spherical surface on a general inner periphery of the race; and
(f) at least one slot formed in the race, said slot having a slot surface and a slot width at least as great as the bushing width, a distance between the slot surface and a nearest race surface diametrically opposite the slot surface being at least as great as the diameter of the bushing.

18. The apparatus of claim 17 wherein the spherical surface on the general inner periphery of the race comprises a first spherical race surface, the apparatus additionally comprising:
(a) a second spherical race surface on a general inner periphery of the race; and
(b) a groove separating the first spherical race surface and the second spherical race surface.

19. The apparatus of claim 17 wherein the at least one slot formed in the race comprises a first slot and the slot surface comprises the first slot surface, the apparatus additionally comprising a second slot formed in the race disposed diametrically opposite the first slot, said second slot having a second slot surface, said first slot surface and said second slot surface being diametrically opposite one another.

20. The apparatus of claim 17 additionally comprising a shaft operatively insertable into an aperture in the bushing.

21. The apparatus of claim 17 wherein the bushing additionally comprises an aperture, said aperture being circular in cross section.

22. The apparatus of claim 17 wherein the bushing additionally comprises an aperture, said aperture being noncircular in cross section.

23. The apparatus of claim 17 wherein the race additionally comprises a face, the apparatus additionally comprising a keeper, operatively affixed to the face of the race and covers the at least one slot, said keeper permits a rotation of the bushing but disallows an exit of the bushing from the race via the at least one slot.

24. The apparatus of claim 17 wherein the bushing is treated using a treatment selected from the group heat treatment and surface treatment, separately from the race.

25. The apparatus of claim 17 wherein the race is treated using a treatment selected from the group heat treatment and surface treatment, separately from the bushing.

25. The apparatus of claim 17 wherein bushing materials making up the bushing are different from race materials making up the race.
